(19) United States
(12) Patent Application Publication
(10) Pub. No.: US 2014/0334671 A1
(43) Pub. Date: Nov. 13, 2014

(54) OBJECT RECOGNITION APPARATUS AND METHOD

(71) Applicant: Electronics and Telecommunications Research Institute, Daejeon (KR)

(72) Inventors: Dong Woo Lee, Daejeon (KR); Hyun Tae Jeong, Daejeon (KR); Sungyong Shin, Daejeon (KR); Hyung Cheol Shin, Daejeon (KR); IL YEON Cho, Daejeon (KR)

(73) Assignee: Electronics and Telecommunications Research Institute, Daejeon (KR)

(21) Appl. No.: 14/132,437

(22) Filed: Dec. 18, 2013

(30) Foreign Application Priority Data
May 9, 2013 (KR) 10-2013-0052687

(51) Int. Cl. G06K 9/00

(52) U.S. Cl. CPC G06K 9/00362
USPC 382/103

(57) ABSTRACT

An object recognition apparatus and method are disclosed. The object recognition apparatus includes: a skin color DB storing skin color information; a pattern light generator that irradiates a pattern light onto an object, which is a part of a human body; an image acquisition unit that receives the pattern light reflected from the object and generates a pattern light image of the object; and an operation unit that recognizes the object based on the skin color information and the pattern light image.

### CROSS-REFERENCE TO RELATED APPLICATION

This application claims priority to and the benefit of Korean Patent Application No. 10-2013-0052687 filed in the Korean Intellectual Property Office on May 9, 2013, the entire contents of which are incorporated herein by reference.

### BACKGROUND OF THE INVENTION

(a) Field of the Invention

The present invention relates to an object recognition apparatus and method, and more particularly, to an image processing technology for bare hand recognition.

(b) Description of the Related Art

Human hands are important body parts capable of performing a range of activities, such as handling equipment and tools, using sign language, and making gestures. Until now, much research has been conducted into the recognition of gestures and postures in order to use user's hands as a natural input tool for a system.

Particularly, a lot of research has been recently done on the recognition of bare hands because using bare hands gives convenience and control.

Hand recognition methods involve using a device such as a data glove or using a camera.

In the case of image processing using a camera, skin color may be used to segment a user's hand from the background, or the user may wear a glove of a color that the camera can capture well to achieve stable performance.

For user convenience, many efforts have been made to recognize bare hands without using additional tools

Camera-based bare hand recognition using skin color is frequently used by virtue of fast image processing. However, partial or complete changes in skin color due to surrounding lighting may cause a reduction in recognition rate.

### SUMMARY OF THE INVENTION

The present invention has been made in an effort to provide an object recognition apparatus and method which use a pattern light image and skin color information.

According to one aspect of the present invention, an object recognition apparatus is disclosed. The object recognition apparatus includes: a skin color DB storing skin color information; a pattern light generator that irradiates pattern light onto an object, which is a part of a human body; an image acquisition unit that receives the pattern light reflected from the object and generates a pattern light image of the object; and an operation unit that recognizes the object based on the skin color information and the pattern light image.

The image acquisition unit may receive visible light reflected from the object and generate a visible light image of the object, and the operation unit may recognize the object by extracting feature points of the object from the pattern light image, mapping the feature points to the visible light image, and extracting the object region from the visible light image to which the feature points are mapped, with reference to the skin color information.

The pattern light generator may include: a light source that produces a beam of light; and a pattern generating element that generates pattern light using the beam received from the light source, and irradiates the pattern light onto the object.

The pattern generating element may include at least one DOE (diffractive optical element) that generates pattern light by preventing light emission in some parts of a pattern on the light emitting surface of the object.

The image acquisition unit may include: a beam splitter that receives a beam reflected from the object and splits the received beam into the pattern light and the visible light; a first image sensor that senses the pattern light split by the beam splitter and generates the pattern light image; and a second image sensor that senses the visible light split by the beam splitter and generates the visible light image.

The image acquisition unit may include: a first filter that allows the pattern light out of the beam reflected from the object to pass therethrough; a first image sensor that senses the pattern light passed through the first filter and generates the pattern light image; a second filter that allows the visible light out of the beam reflected from the object to pass therethrough; and a second image sensor that senses the visible light passed through the second filter and generates the visible light image.

According to another aspect of the present invention, an object recognition method includes: irradiating pattern light onto an object, which is a part of a human body; and recognizing the object based on a pattern light image, which is generated using the pattern light received and reflected from the object, and stored skin color information.

In the recognizing, the object may be recognized based on a visible light image, which is generated using visible light received and reflected from the object, the pattern light image, and the skin color information.

The recognizing may include: detecting a pattern distortion in the pattern light image; extracting feature points of the object based on start and end points of the detected pattern; detecting a position of the object on the pattern light image and the shape of the objet, based on the feature points; mapping the feature points to the visible light image; and extracting the accurate object region on the visible light image with reference to the skin color information, based on the feature points.

The method may further include: prior to the recognizing, splitting the beam reflected from the object into the pattern light and the visible light; sensing the pattern light and generating the pattern light image; and sensing the visible light and generating the visible light image.

The method may further include, prior to the recognizing: receiving the beam reflected from the object; filtering the received beam to separate the pattern light and generate the pattern light image; and filtering the received beam to separate the visible light and generate the visible light image.

According to an embodiment of the present invention, image processing for bare hand recognition is performed using a pattern light image and skin color, and therefore a low recognition rate due to the surrounding lighting is improved, compared to the prior art which uses only skin color out of a visible light image.

Moreover, skin color is actively detected when the skin color of hands is entirely or partially changed due to surrounding lighting, thereby enabling more stable bare hand recognition as compared to the prior art.

### BRIEF DESCRIPTION OF THE DRAWINGS

FIG. 1 is a block diagram of an object recognition apparatus in accordance with an exemplary embodiment of the present invention.

FIG. 2 shows an example of the application of an object recognition apparatus in accordance with an exemplary embodiment of the present invention.

FIG. 3 shows an example of the application of an object recognition apparatus in accordance with another exemplary embodiment of the present invention.

FIG. 4 is a detailed block diagram of a pattern light generator of FIG. 1.

FIG. 5 shows a visible light image in accordance with an exemplary embodiment of the present invention.

FIG. 6 shows a pattern light image in accordance with an exemplary embodiment of the present invention.

FIG. 7 is a detailed block diagram of an image acquisition unit in accordance with an exemplary embodiment of the present invention.

FIG. 8 is a detailed block diagram of an image acquisition unit in accordance with another exemplary embodiment of the present invention.

FIG. 9 is an illustration of pattern extraction in accordance with an exemplary embodiment of the present invention.

FIG. 10 is an illustration of feature point extraction in accordance with an exemplary embodiment of the present invention.

FIG. 11 is an illustration of object region extraction in accordance with an exemplary embodiment of the present invention.

FIG. 12 is a flowchart showing an object method in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise” and variations such as “comprises” or “comprising” will be understood to imply the inclusion of stated elements but not the exclusion of any other elements.

Now, an object recognition apparatus and method in accordance with an exemplary embodiment of the present invention will be described with reference to the drawings.

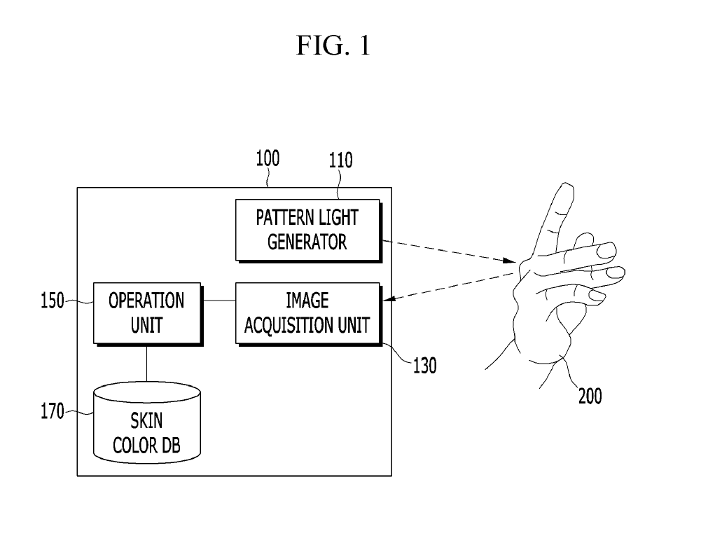

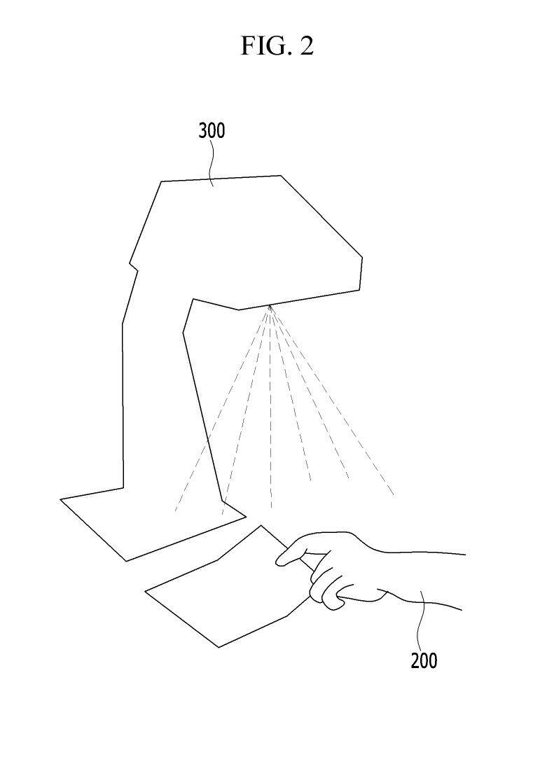

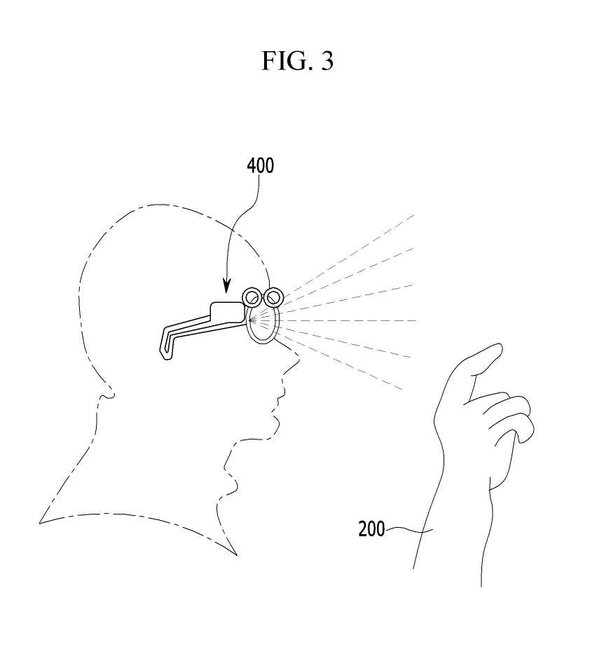

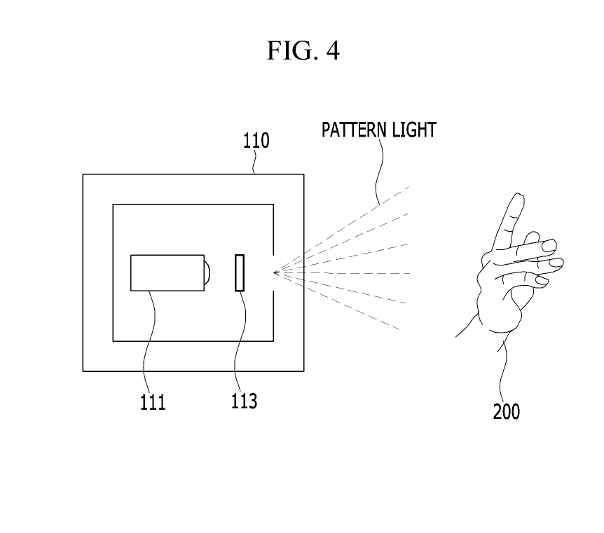

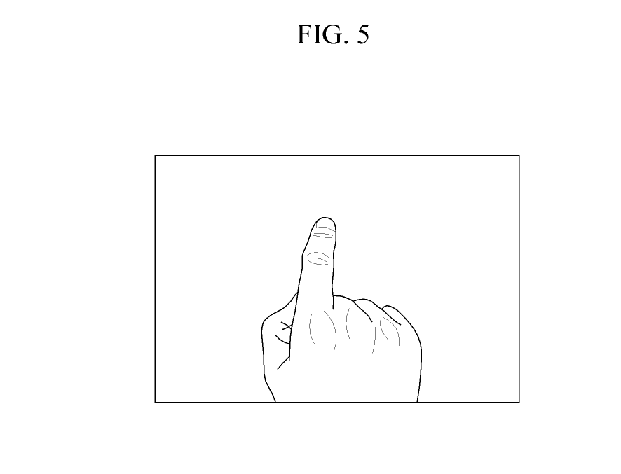

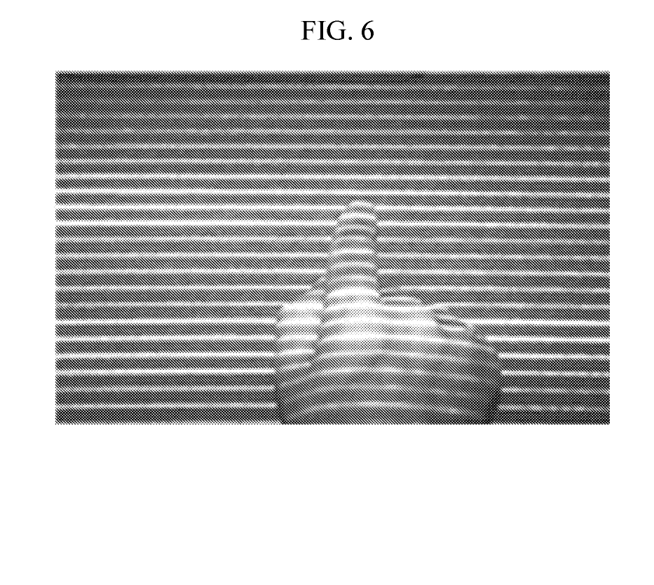

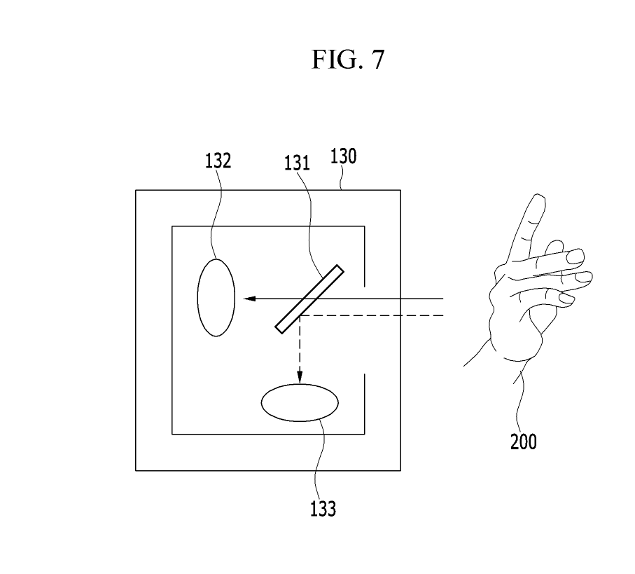

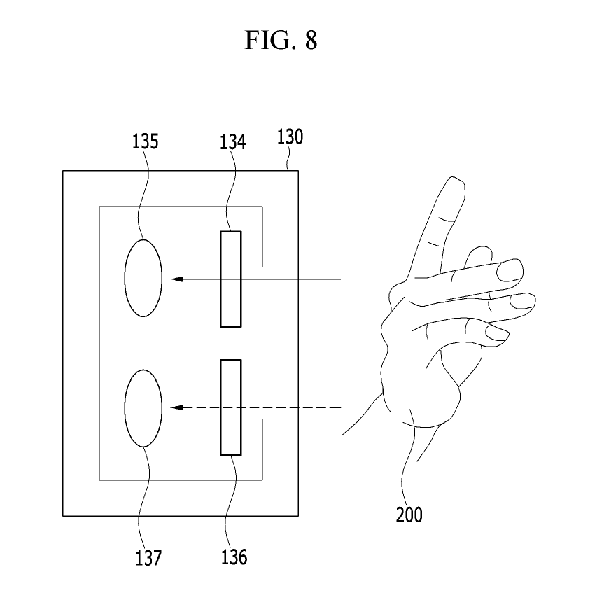

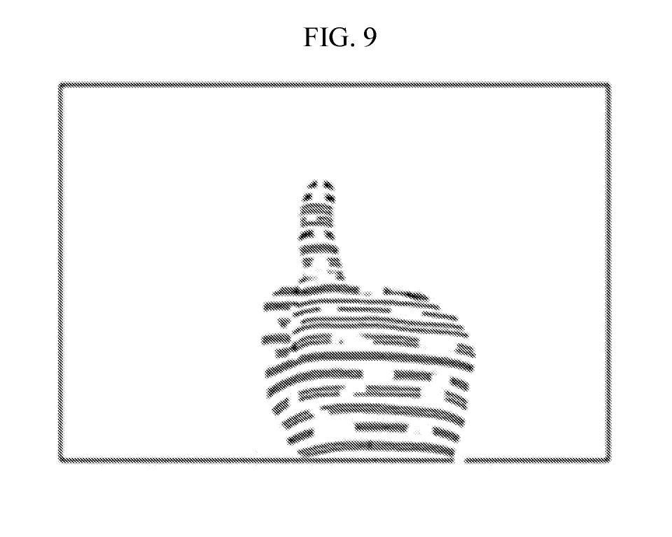

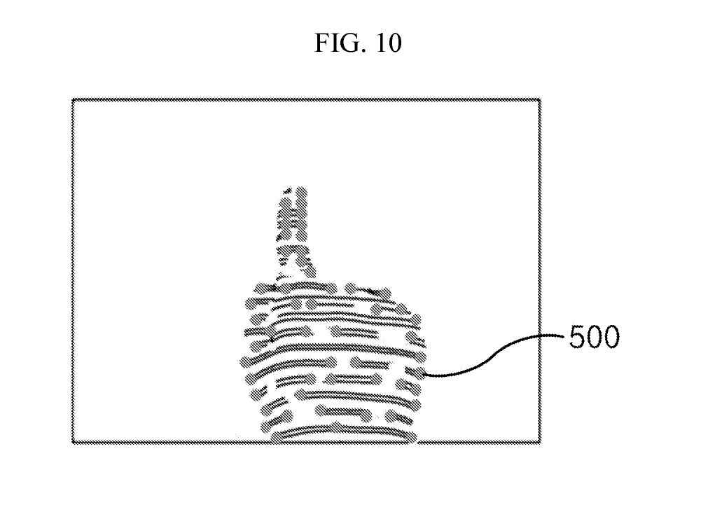

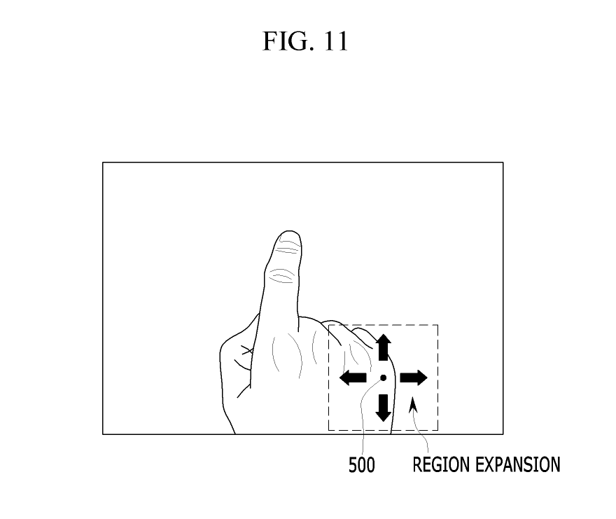

FIG. 1 is a block diagram of an object recognition apparatus in accordance with an exemplary embodiment of the present invention, FIG. 2 shows an example of the application of an object recognition apparatus in accordance with an exemplary embodiment of the present invention, FIG. 3 shows an example of the application of an object recognition apparatus in accordance with another exemplary embodiment of the present invention, FIG. 4 is a detailed block diagram of a pattern light generator of FIG. 1, FIG. 5 shows a visible light image in accordance with an exemplary embodiment of the present invention, FIG. 6 shows a pattern light image in accordance with an exemplary embodiment of the present invention, FIG. 7 is a detailed block diagram of an image acquisition unit in accordance with an exemplary embodiment of the present invention, FIG. 8 is a detailed block diagram of an image acquisition unit in accordance with another exemplary embodiment of the present invention, FIG. 9 is an illustration of pattern extraction in accordance with an exemplary embodiment of the present invention, FIG. 10 is an illustration of feature point extraction in accordance with an exemplary embodiment of the present invention, and FIG. 11 is an illustration of object region extraction in accordance with an exemplary embodiment of the present invention.

First of all, referring to FIG. 1, an object recognition apparatus 100 recognizes an object 200 by acquiring and processing an image of the object 200.

The object 200 is a part of a human body. According to one embodiment, the object 200 includes a bare hand without anything on it.

As shown in FIG. 2, the object recognition apparatus 100 may be applied to a table-mounted protection system 300.

As shown in FIG. 3, the object recognition apparatus 200 also may be applied to glasses 400.

Referring again to FIG. 1, the object recognition apparatus 100 includes a pattern light generator 110, an image acquisition unit 130, an operation unit 150, and a skin color DB 170.

The pattern light generator 110 emits pattern light to generate a pattern light image. The pattern light refers to light which is generated based on the principles of diffraction and refraction of light, and has a specific image pattern.

The pattern light generator is 110 is embodied as shown in FIG. 4.

Referring to FIG. 4, the pattern light generator 110 includes a light source 111 and a pattern generating element 113.

The light source 111 produces a beam of light, i.e., invisible light such as infrared light. The light source 111 may include an LED (light emitting diode), an LD (laser diode), etc.

The pattern generating element 113 generates pattern light using the light beam received from the light source 111, and irradiates it onto the object 200.

The pattern generating element 113 is an optical element, and may include a DOE (diffractive optical element) according to an embodiment.

The image acquisition unit 130 receives visible light reflected from the object 200 and generates a visible light image shown in FIG. 5.

Moreover, the image acquisition unit 130 receives pattern light reflected from the object 200 and generates a pattern light image shown in FIG. 6.

According to an embodiment, the image acquisition unit 130 may be embodied as shown in FIG. 7.

Referring to FIG. 7, the image acquisition unit 130 includes a beam splitter 131, a first image sensor 132, and a second image sensor 133.

The beam splitter 131 receives a beam reflected from the object 200 and splits it into pattern light and visible light.

The first image sensor 132 senses the pattern light split by the beam splitter 131 and generates a pattern light image.

The second image sensor 133 senses the visible light split by the beam splitter 131 and generates a visible light image.

According to another embodiment, the image acquisition unit 130 may be embodied as shown in FIG. 8.

Referring to FIG. 8, the image acquisition unit 130 includes a first filter 134, a first image sensor 135, a second filter 136, and a second image sensor 137.

The first filter 134 allows pattern light, out of the beam reflected from the object 20, to pass therethrough.

The first image sensor 135 senses the pattern light passed through the first filter 134 and generates a pattern light image.

The second filter 136 allows visible light, out of the beam reflected from the object 200, to pass therethrough.

The second image sensor 137 senses the visible light passed through the second filter 136 and generates a visible light image.

The first filter 134 and the second filter 136 may either block or allow particular wavelengths to pass through.

In FIG. 7 and FIG. 8, the first image sensors 132 and 135 and the second image sensors 133 and 137 convert a received light signal into an electrical signal, and output it as an image signal. For example, they may include a CCD (charged coupled device) or a CMOS (complementary metal oxide semiconductor).

The operation unit 150 recognizes the object 200 based on the visible light image and pattern light image transferred from the image acquisition unit 130 and the skin color information stored in the skin color DB 150.

The operation unit 150 detects a distortion in the pattern light image of FIG. 6, caused by the object, i.e., the hand, and extracts a pattern showing the position of the hand on the pattern light image and the overall shape of the hand, which is as shown in FIG. 9. In this way, a plurality of feature points 500 are extracted from the detected pattern, mainly based on the start and end points of the pattern.

With the plurality of extracted feature points 500 mapped to the visible light image of FIG. 5, the operation unit 150 extracts the accurate hand region while expanding it, as shown in FIG. 11, with reference to the skin color information. That is, the operation unit 150 distinguishes a hand region and a non-hand region on the visible light image, by expanding the hand region with reference to the skin color information, based on the feature points 500.

Based on the above description, a series of steps of object recognition will be explained below. The same reference numerals are used to designate the same components explained in FIGS. 1 to 11.

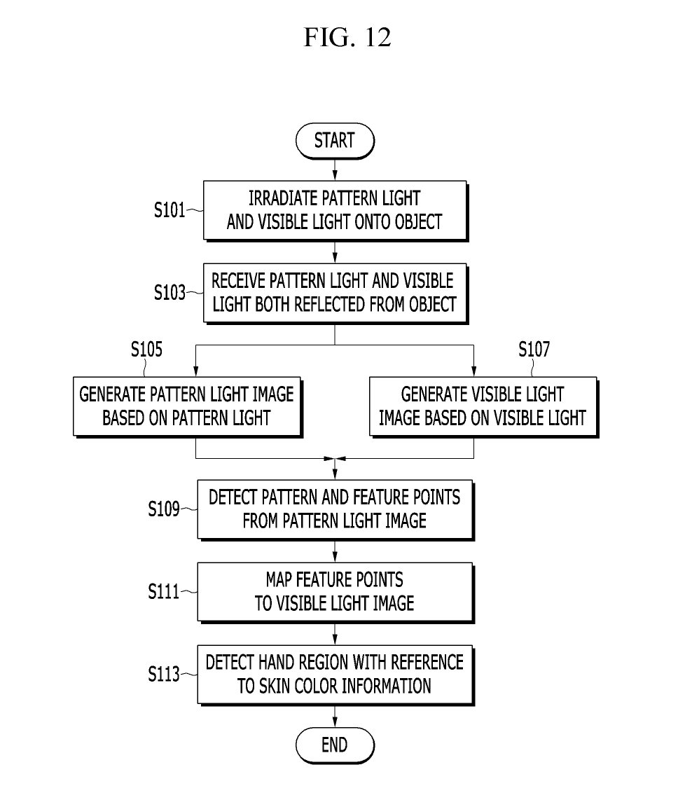

FIG. 12 is a flowchart showing an object method in accordance with an exemplary embodiment of the present invention.

Referring to FIG. 12, the pattern light generator 110 irradiates pattern light onto the object 200 (S101).

The image acquisition unit 130 receives pattern light and visible light both reflected from the object 200 (S103), and generates a pattern light image and a visible light image (S105 and S107).

The step S103 may include splitting a received beam into pattern light and visible light by the beam splitter 131, as explained in FIG. 7.

Further, step S103 may include filtering the received beam to separate the pattern light and the visible light through the first filter 134 and the second filter 136, respectively, as explained in FIG. 8.

The operation unit 150 extracts a pattern, which shows the position of the hand and the overall shape of the hand, and feature points (500 of FIG. 10) from the pattern light image generated in step S105 (S109).

The operation unit 150 maps the feature points extracted in step S109 to the visible light image generated in step S107 (S111).

The operation unit 150 detects the hand region from the visible light image to which the feature points are mapped, with reference to the skin color information (S113).

The exemplary embodiment of the present invention is not implemented only by the above-explained device and/or method, but can be implemented through a program for realizing functions corresponding to the configuration of the exemplary embodiments of the present invention and a recording medium having the program recorded thereon. Such implementation can be easily made by a skilled person in the art to which the present invention pertains from the above description of the exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An object recognition apparatus comprising:
a skin color DB storing skin color information;
a pattern light generator that irradiates pattern light onto an object, which is a part of a human body;
an image acquisition unit that receives the pattern light reflected from the object and generates a pattern light image of the object; and
an operation unit that recognizes the object based on the skin color information and the pattern light image.

2. The object recognition apparatus of claim 1, wherein the image acquisition unit receives visible light reflected from the object and generates a visible light image of the object, and
the operation unit recognizes the object by extracting feature points of the object from the pattern light image, mapping the feature points to the visible light image, and extracting the object region from the visible light image to which the feature points are mapped, with reference to the skin color information.

3. The object recognition apparatus of claim 2, wherein the pattern light generator comprises:
a light source that produces a beam of light; and
a pattern generating element that generates pattern light using the beam received from the light source, and irradiates the pattern light onto the object.

4. The object recognition apparatus of claim 3, wherein the pattern generating element comprises at least one DOE (diffractive optical element) that generates pattern light by preventing light emission in some parts of a pattern on the light emitting surface of the object

5. The object recognition apparatus of claim 3, wherein the image acquisition unit comprises:
a beam splitter that receives a beam reflected from the object and splits the received beam into the pattern light and the visible light;
a first image sensor that senses the pattern light split by the beam splitter and generates the pattern light image; and
a second image sensor that senses the visible light split by the beam splitter and generates the visible light image.

6. The object recognition apparatus of claim 3, wherein the image acquisition unit comprises:
a first filter that allows the pattern light out of the beam reflected from the object to pass therethrough;
a first image sensor that senses the pattern light passed through the first filter and generates the pattern light image;
a second filter that allows the visible light out of the beam reflected from the object to pass therethrough; and
a second image sensor that senses the visible light passed through the second filter and generates the visible light image.

7. An object recognition method comprising:
irradiating pattern light onto an object, which is a part of a human body; and
recognizing the object based on a pattern light image, which is generated using the pattern light received and reflected from the object, and stored skin color information.

8. The object recognition method of claim 7, wherein, in the recognizing, the object is recognized based on a visible light image, which is generated using visible light received and reflected from the object, the pattern light image, and the skin color information.

9. The object recognition method of claim 8, wherein the recognizing comprises:
detecting a pattern distortion in the pattern light image;
extracting feature points of the object based on start and end points of the detected pattern;
detecting a position of the object on the pattern light image and the shape of the objet, based on the feature points;
mapping the feature points to the visible light image; and
extracting the accurate object region on the visible light image with reference to the skin color information, based on the feature points.

10. The object recognition method of claim 9, further comprising,
prior to the recognizing:
splitting the beam reflected from the object into the pattern light and the visible light;
sensing the pattern light and generating the pattern light image; and
sensing the visible light and generating the visible light image.

11. The object recognition method of claim 9, further comprising,
prior to the recognizing:
receiving the beam reflected from the object;
filtering the received beam to separate the pattern light and generate the pattern light image; and
filtering the received beam to separate the visible light and generate the visible light image.
